(19) United States
(12) Patent Application Publication
(10) Pub. No.: US 2016/0231915 A1
(43) Pub. Date: Aug. 11, 2016

(54) REAL-TIME PRESENTATION OF CUSTOMIZABLE DRILL-DOWN VIEWS OF DATA AT SPECIFIC DATA POINTS

(71) Applicant: Microsoft Technology Licensing, LLC., Redmond, WA (US)

(72) Inventors: Thomas Q. Nhan, Seattle, WA (US); Jai Srinivasan, Bellevue, WA (US); Bhargavi Parthasarathy Hiremagalur, Renton, WA (US); Daniel Benjamin Witriol, Kirkland, WA (US)

(73) Assignee: Microsoft Technology Licensing, LLC., Redmond, WA (US)

(21) Appl. No.: 14/735,287

(22) Filed: Jun. 10, 2015

Related U.S. Application Data
(60) Provisional application No. 62/114,419, filed on Feb. 10, 2015.

(51) Int. Cl. G06F 3/0484; G06F 3/0481; G06F 17/24; G06T 11/20

(52) U.S. Cl. CPC G06F 3/04847; G06T 11/206; G06F 3/04842; G06F 3/04812; G06F 17/248; G06T 2200/24

(57) ABSTRACT

Methods and systems for providing customizable drill-down views for data points within a data visualization are provided herein. Data cards are displayed alongside data points within a data visualization to provide supplemental views and supplemental data for the visualized data associated with the data point. Data cards are operable to be temporary, or pinned to be semi-permanent, displays of data within the data visualization. Data cards are operable to query data in real time and aggregate and manipulate data for display. Queried data includes data present in the data visualization, used and not, and data from external data sources. Aspects of the methods and systems provide for automatic and manual control of various aspects.

### CROSS REFERENCE TO RELATED APPLICATIONS

This application claims the benefit of U.S. Provisional Patent Application No. 62/114,419, titled “Real-time Presentation of Customizable Drill-down Views of Data at Specific Data Points” filed Feb. 10, 2015.

### BACKGROUND

A variety of methods and systems are available for presenting data to users, however, many methods and systems fail to present the most up-to-date data. When those data are presented, accessing and storing the data requires vast amounts of system resources. Additionally, the data are presented in a limited fashion when displayed in a visualization. It is with respect to these and other considerations that examples will be made.

### SUMMARY

This summary is provided to introduce a selection of concepts in a simplified form that are further described below in the Detailed Description section. This summary is not intended to identify all features of the claimed subject matter, nor is it intended to limit the scope of the claimed subject matter.

Aspects of a data card system provide data to users in real-time that is relevant to points of interest in the data visualization. Further, aspects of the present disclosure are directed to data cards that are operable to present data that are collected in real-time, on-the-fly, for presentation within a data visualization that could not previously be presented via the data visualization. The data card system is therefore operable to decrease the needs for system resources and increase the responsiveness of data presentation.

Additionally, users are able to see data cards before deciding whether to pin the data cards as part of the data visualization, and thus, increasing productivity by giving users a quick way to determine which data points should be drilled-down into to provide additional related data for further review.

Examples may be implemented as a computer process, a computing system, or as an article of manufacture such as a computer program product or computer readable media. The computer program product may be a computer storage media readable by a computer system and encoding a computer program of instructions for executing a computer process. The details of one or more aspects are set forth in the accompanying drawings and description below. Other features and advantages will be apparent from a reading of the following detailed description and a review of the associated drawings. It is to be understood that the following detailed description is explanatory only and is not restrictive of the scope of the subject matter as claimed.

### BRIEF DESCRIPTION OF THE DRAWINGS

The accompanying drawings, which are incorporated in and constitute a part of this disclosure, illustrate various aspects of the present disclosure. In the drawings:

FIG. 1 is a block diagram of an example data visualization system;

FIGS. 2A and 2B are examples of data cards;

FIG. 2C illustrates example data cards displayed within an example data visualization;

FIG. 3 is an illustration of an example customization dialog for a data card;

FIG. 4 is an illustration of a visualization control for a data visualization in coordination with a data card;

FIG. 5 illustrates an example time slider;

FIG. 6 is a flow chart of an example method for presenting a custom drill-down view of data at a specific data point within a data visualization

FIG. 7 is a flow chart of an example method for populating a data card;

FIG. 8 is a block diagram illustrating physical components (i.e., hardware) of a computing device;

FIGS. 9A and 9B illustrate a mobile computing device; and

FIG. 10 illustrates one example of the architecture of a system for providing a real-time presentation of customizable drill-down views of data at specific data points.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is non-limiting, and instead, the proper scope is defined by the appended claims. Examples may take the form of a hardware implementation, or an entirely software implementation, or an implementation combining software and hardware aspects. The following detailed description is, therefore, not to be taken in a limiting sense.

As will be understood, data visualizations, such as maps, charts, graphs, etc., provide users with visualizations of data points to provide insights for presentation and storytelling related to one or more datasets. For example, a bar-chart data visualization provides several bars to represent data points, wherein the length of each bar may represent a value for a corresponding data point so that a user may visually compare values across data points. Each data point may be associated with several datasets to represent an entity within a data visualization. For example, a first dataset may specify positional data for the data point in a map-type data visualization and a second dataset may specify a color for that data point, so that, for example, a user may visually compare concentrations of entity types in a region based on their color in the corresponding map (e.g., restaurants appear as blue diamonds on the map corresponding to their location, retailers as green diamonds, etc.).

Data cards enable the provision of additional information to a user in context with a data point for presentation and storytelling with greater control and insight than a data visualization alone can provide. The data fields within a data card provide for the presentation of alternative or additional displays of visualized data as well as the display of non-visualized data, such as, for example, datasets not used as visualization data, rich text descriptions, images, videos, audio files, and hyperlinks or other active controls.

Users define, through a customization dialog, what information associated with a data point is to be shown and how to aggregate that information in a data card. Custom queries are generated as a user approaches or selects a data point within a data visualization. Queries are made in real-time (i.e., on-the-fly) so that users are presented with the most up-to-date information with lower memory costs than possible via pre-defined queries or queries reliant on cached or pre-processed information. By choosing which data points are of interest, and querying in real-time, the system can reduce the storage requirements and processing requirements by focusing on only data points of actual interest to a user instead of relying solely on visualization-wide queries or pre-cached information. Information queried in real-time, according to various aspects, may be aggregated over time, and users are thereby provided the ability to compare data points at different times or animate the flow of time to visualize changes to data points over time.

Data cards are also operable to be pinned within the data visualization or within an application presenting a data visualization with a data card pane. According to aspects, pinning a data card allows for the data card and its information to persist in the data visualization between sessions and display updates to the displayed data (e.g., during playback of data, during collection of data, in response to a customization of the data card etc.).

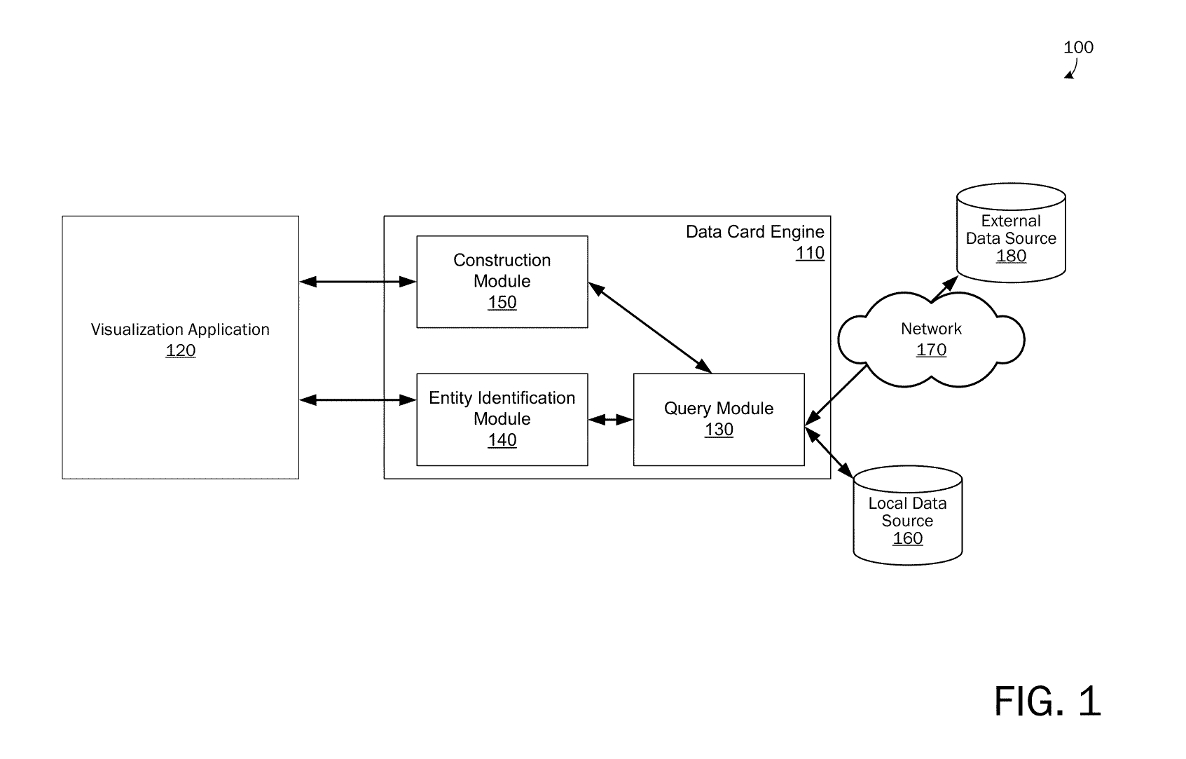

FIG. 1 is a block diagram of an example data visualization system 100. According to an aspect, components of the data visualization system 100 operate as a distributed system, where each module is accessed via a suitable network. According to another aspect, various components of the data visualization system 100 operate together as an integrated system. As illustrated, the data visualization system 100 includes a data card engine 110 in communication with a visualization application 120 to provide real-time presentation of custom drill-down views of data for specific data points via the visualization application 120.

Visualization application 120 is operable to display various visualizations of data and to allow users to navigate those data visualizations. Visualizations of data include maps, charts, graphs, etc. In some aspects, visualization application 120 combines several visualizations. For example, a map showing the location of buildings may include a chart displaying the property taxes assessed on the buildings as columns at the corresponding location of the buildings on the map. Visualization application 120 in some aspects is a stand-alone application and in other aspects is an integrated component of another application, such as, for example an Excel® spreadsheet software or a map sub-application of the Bing® search engine, both offered by MICROSOFT CORPORATION of Redmond, Wash. Data visualizations comprise data points, operable to convey visualizations of data of interest to a user based on an initial query for the data visualization, and environmental data, in which the data points are displayed. Environmental data, in various aspects, includes coordinate spaces (e.g., Cartesian, polar, longitude/latitude, etc.), background images (e.g., maps), scales, and other data used to plot and render data points within an environment of a data visualization.

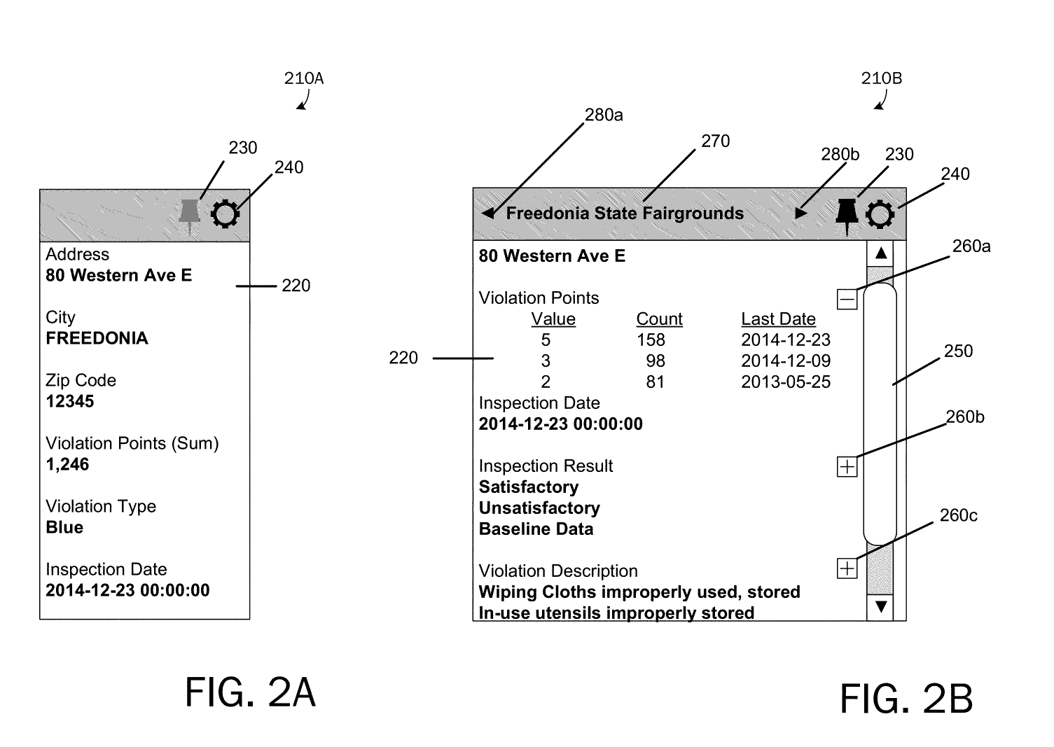

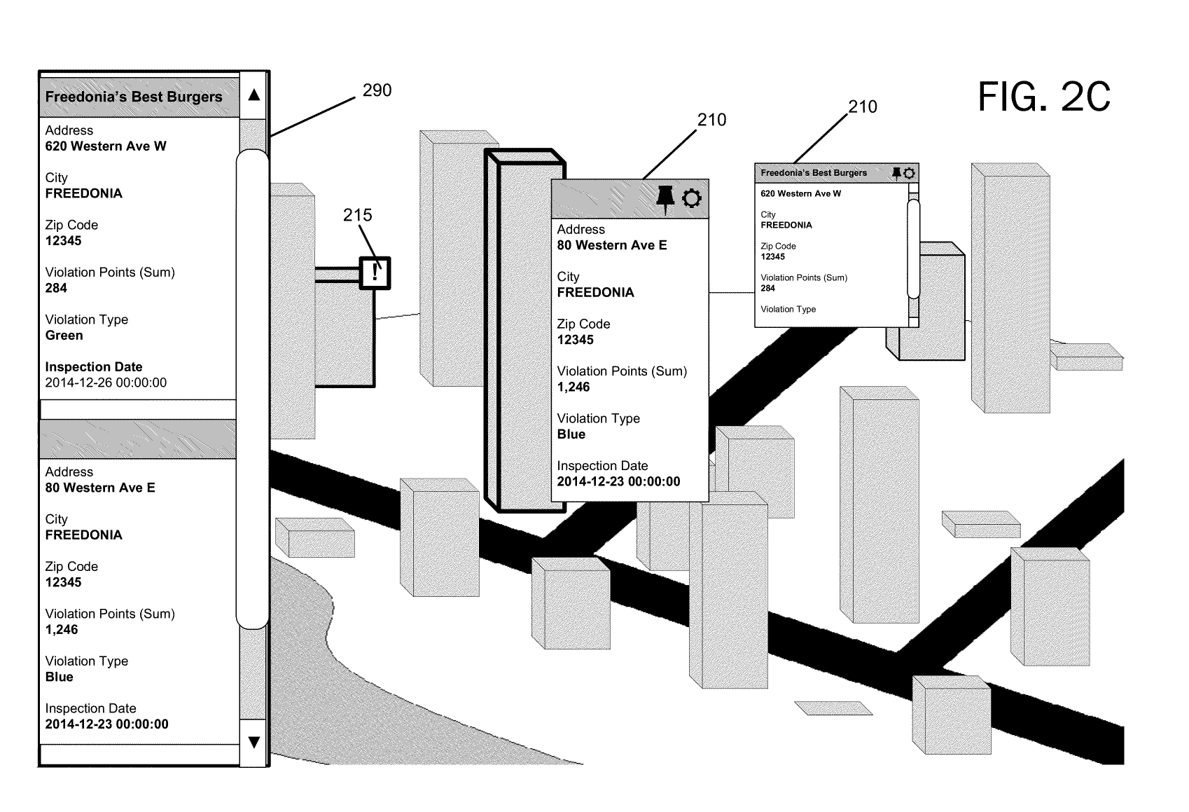

The data card engine 110 is operable to provide data in real-time to supplement the data points within the data visualization. The data card engine 110 provides users the ability to drill-down into a data point on-the-fly to discover additional information related to the data point, or to see alternative visualizations of the data associated with the data point. In some aspects, the data card engine 110 is part of a visualization application 120. The data card engine 110 comprises a query module 130, operable to retrieve data for use in the data card engine 110 from a variety of sources, an entity identification module 140, operable to receive communications (e.g., selections of data points) from the visualization application 120 and to identify what entity the data point represents for use by the query module 130, and a construction module 150, operable to build and update data cards (210) using the data retrieved from data sources by the query module 130. As discussed in greater detail in regard to FIG. 2, data cards 210 are operable to display data within the visualization application 120 for a corresponding data point. In various examples, the data card 210 may include data not used in the visualization of that data point or not capable of being otherwise displayed via a data visualization.

The entity identification module 140 is operable to receive data point selections from the visualization application 120 to identify the data points for use by the query module 130. In various data visualizations, data points represent various entities. In one example of a data visualization for mapping health codes violations, the data points represent the restaurants receiving health code violations. In another example of a data visualization for mapping fuel economy, the data points represent portions of roads. In yet another example of a data visualization of productivity in a factory, the data points represent individual workers. In some aspects, the entity identification module 140 is operable to determine the entity represented by a data point by receiving data fields from the visualization application 120 and determining which of the data fields can be used to identify the entity that the data point represents. In one example, the entity identification module 140 is operable to determine that geographic data (e.g., an address, latitude/longitude coordinates, etc.) from the visualization application 120 are operable to identify the entity, which the entity identification module 140 uses to flag the geographic data for the query module 130 to use in determining query-related data identifying the entity to build further queries. When multiple entities correspond to a selected data point (e.g., multiple tenants at a single address on a map data visualization) the entity identification module 140 is operable to identify that multiple entities exist and communicate the multiple entities to the query module 130 so that multiple queries are run (e.g., at least one for each identified entity), or queries are run for only specified entities from the identified entities.

The query module 130 is operable to retrieve data relating to an entity associated with a data point, which is specified by data fields set in the construction module 150. The query module 130 is operable to retrieve data via various methods from various sources. In one aspect, data is retrieved from a local data source 160, such as, for example, cached data used to build the data visualization or a file hosted or stored by the computing device executing the data card engine 110. In other aspects, data is retrieved via a network 170 from an external data source 180. External data sources 180 include, in various aspects, any file, data, or information not stored locally by the computing device executing the data card engine 110. To locate data, aspects enable a user to specify a specific data source from which to query data, for example, a user may designate a specific range from an spreadsheet file stored locally, an IP address for a database stored on a local network, or a URL for a website hosted on the internet. In other aspects, the query module 130 is operable to access a search engine (e.g., the Bing® search engine offered by MICROSOFT CORPORATION of Redmond, Wash.) to automatically locate data sources to query for data. In yet other aspects, the query module 130 is operable to seek approval from a user to automatically locate data sources. Once a data source has been identified, the query module 130 is operable to retrieve data from the data source.

The construction module 150 is operable to build and update data cards (210) using the data retrieved from data sources by the query module 130. In various aspects, the data is assembled according to data card templates, which may be pre-defined by the data visualization system 100 or manually specified by users of the data visualization system 100. The data card template is operable to specify an order and manner for displaying retrieved data. In some aspects, the construction module 150 is operable to manipulate numerical data for: setting hierarchical relationships and dependencies between data, aggregating the data, and displaying the data in tables, charts, and graphs within the data card (210). In additional aspects, the construction module 150 is operable to manipulate non-numerical data (e.g., rich text comments, videos, images, etc.) for: setting hierarchical relationships and dependencies between data, creating and manipulating numerical data related to the non-numerical data (e.g., aggregating a count of unique comments), and displaying the data within the data card (210).

The construction module 150 is operable to communicate customizations of a data card template to the query module 130 so that data related to the customized data card template can be retrieved. For example, when a user adds a data field to the data card template, the construction module 150 communicates the data fields to the query module 130 to retrieve data to populate the data fields. While data is being retrieved by the data query module 130, the construction module 150 is operable to display a placeholder value (e.g., “Query Pending,” “Searching,” or “Please Wait”) for the data field being queried. In the event that the query module 130 retrieves insufficient data, or otherwise encounters an error, the construction module 150 is operable to display an error value (e.g., “File not Found,” “Insufficient Data,” “Error,” etc.). In the event that the query module 130 retrieves conflicting data (e.g., two telephone numbers, different statistical data for the same time period, etc.), the construction module 150 is operable to display an error value, display the conflicting data concurrently, automatically select one of the conflicting data, or prompt a user to manually select one of the conflicting data.

FIGS. 2A and 2B are examples of data cards. FIG. 2A is a first example of a data card 210a. FIG. 2B is a second example of a customized data card 210B. Data cards 210a, 210b (collectively 210) are illustrated as related to the same hypothetical data point, demonstrating some of the flexibility of data cards 210 in presenting data related to data points within data visualizations.

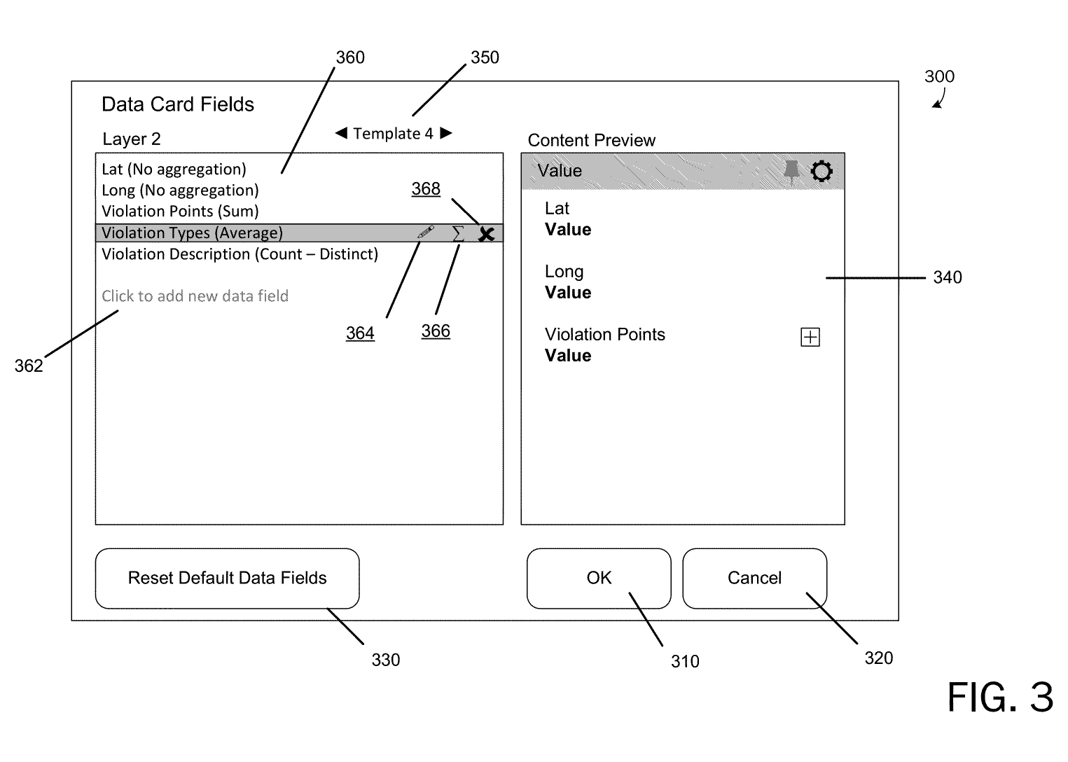

Data cards 210 are provided with a display area 220 to display various data related to the data point of the data card 210. Controls, such as for example, a pin control 230, represented by an icon of a pin in the illustrated examples, and a customization control 240, represented by an icon of a gear in the illustrated examples, may also be provided. The pin control 230 is operable to receive user selection to pin the data card 210, thereby persisting the data card 210 within the data visualization or in a data card pane 290 displayed proximate to the data visualization, as illustrated in FIG. 2C. Multiple data cards 210 may be concurrently pinned. According to various aspects, the pin control 230 may be represented by different icons or icons in different positions/orientations/colors to indicate to a user whether a data card 210 has been pinned, such as the darkened icon of pin control 230 in FIG. 2B indicating that data card 210B has been pinned, whereas the lighter icon of pin control 230 in FIG. 2A indicates data card 210A is unpinned. The customization control 240 is operable to receive user input to update the data card 210, which is discussed further in relation to FIG. 3.

Aspects provide for the name of the entity associated with the data point of the data card 210 to be provided in a title area 270. The entity name may be returned in a query, set by a user, or auto-named (e.g., Entity1, Entity2, etc.). In some aspects, the title area 270 is selectable by the user to add or edit text for the entity name. In some aspects, the title area 270 includes navigation controls 280a, 280b (collectively, 280) to permit navigation of multiple entities which may be represented by a data card 210. For example, a data point may be associated with multiple entities, such as when a building has had multiple tenants over a period of time or multiple tenants at once, and the data card 210 may include navigation controls 280 to allow navigation between these entities. In other aspects, a data visualization system may be unsure of which data point has been selected, such as, for example, when the data visualization is “zoomed out,” and accordingly will provide a data card 210 for one potentially selected data point and provide navigation controls 280 to allow navigation to the other potentially selected data points. As will be understood, navigation control 280a and navigation control 280b are provided according to aspects for navigation in different directions through potential data points or entities. As will also be understood, navigation may loop or have distinct start and end points according to different aspects; navigation control 280a or 280b may thus be disabled, and be accordingly illustrated (e.g., grayed out, omitted, etc.), when navigation has reached an end point for their direction of navigation.

When appropriate, aspects also provide controls for the display area 220. A scrollbar 250 may be provided when more data exists on the data card 210 than the display area 220 can display at one time, allowing a user to view portions of the data. Expand/collapse controls 260 may also be provided to receive user input to expand or collapse views of data present in the display area 220. Expand/collapse control 260a is illustrated as a “minus” icon, indicating that a user may toggle expand/collapse control 260a to collapse associated data, illustrated in FIG. 2B as expanded data on Violation Points. Similarly, expand/collapse controls 260b, 260c are illustrated as “plus” icons, indicating that a user may toggle expand/collapse controls 260b, 260c to expand associated data.

As will be understood, data, in its collapsed form, may comprise various aggregations of the data and may omit subsets of related data. For example, FIG. 2B illustrates expanded data for Violation Points, including value, count, and last date subsets of related data. If the data for Violation Points were collapsed, for example by a user toggling expand/collapse control 260a, the data card 210b, according to one aspect, may aggregate the sum of Violation Points, as is illustrated in FIG. 2A, and omit the last data subset from its aggregation. According to another aspect, the data card 210 may aggregate the count of violations and omit the value and last date subsets. The system is operable to select an initial display and aggregation template, and a user may change the initial template by selecting the customization control 240, an associated menu or ribbon control, or the customization control of a different data card 210 having the same data card template.

FIG. 2C illustrates example data cards 210 displayed within an example data visualization. The data cards 210 are illustrated alongside visualizations of the data cards' data points. In some aspects, a visualization of a data point associated with a data card 210 is highlighted, such as is illustrated in FIG. 2C. According to aspects, multiple data cards 210 may be pinned for concurrent display in the data visualization. Aspects allow for data cards 210 to be pinned in a data card pane 290 in addition to, or instead of, within the data visualization. Data cards 210 are also operable to be pinned as an annotation 215 within the data visualization. Annotations 215 are operable to alert a user that a data point is of interest, but without presenting the display area 220 of the data card 210, thereby taking up less space within the data visualization than a full data card 210. Annotation 215 is illustrated in FIG. 2C as an “exclamation” icon, but other aspects allow for annotations 215 to include information from the title area 270 to help a user identify the data point.

The example data visualization of FIG. 2C is illustrated using three-dimensional environmental data in which visualized data points are presented. In various aspects, data cards 210 are scaled according to how close they are to the foreground of the data visualization to create perspective; data cards 210 displayed in the foreground are displayed larger than data cards 210 displayed in the background. Because data cards 210 are displayed in the example as two-dimensional objects, if a user rotates the data visualization, the data cards 210 are operable to counter-rotate, so that the data card faces the foreground. Although the example data visualization is shown as a three-dimensional map-like visualization, the features illustrated in the figures are for purposes of example only and are not restrictive of other uses such as, for example, graphs, charts, or two-dimensional maps.

FIG. 3 is an illustration of an example customization dialog 300 for a data card 210. The example customization dialog 300 includes: OK button 310, operable to accept and implement current changes to a data card 210, and thereby close customization dialog 300; Cancel button 320, operable to reject the current changes to a data card 210, and thereby close customization dialog 300; and Reset button 330, operable to revert the current and previous changes to a data card 210 to the default state of the data card 210. Customization dialog 300 is also illustrated with a preview pane 340 to display the data card 210 according to the current changes.

Aspects of the customization dialog 300 provide for a template control 350, operable to enable a user to quickly cycle through and select a desired system-defined templates or user-defined templates, and thereby propagate changes made in one data card 210 to other data cards 210 having the same template or set the data card 210 to a desired format that is already defined. For example, if two data cards 210 were set as having the same template, adding a data field to the template will add the data field to both data cards 210. In another example, when a data card 210 has its template changed, the data fields and display settings for the data card 210 will be set to match the template, and, in some aspects, any corresponding queries may be run to populate newly added data fields.

The customization dialog 300 also includes a data field control 360. The data field control 360 is operable to provide a user with control over which subsets of data (e.g., data fields) are presented on the data card 210, how those subsets are organized, how the subsets are aggregated, and how the data is displayed. Addition control 362 is provided so that a user may query for additional data subsets to include on the data card 210. Once a data subset has been included on the data card 210, according to an aspect, a user may select a data field within the data field control 360 to move by dragging and dropping the data field to a desired position to affect a change in position on the data card 210. According to other aspects, selecting the data field will provide additional controls, such as, for example, edit control 364, aggregation control 366, and remove control 368. An edit control 364 allows a user to set relationships between data subsets, rename a data subset, set data offsets, set filters on the data subset, set the visibility of the subset, and the like. An aggregation control 366 allows a user to set how the data subset is aggregated. Example aggregations include, but are not limited to: no aggregation, sum, product, mean (average), median, mode, count, count distinct, maximum, minimum, latest entry, earliest entry, logical checks, and variations and combinations thereof. A remove control 368 allows a user to remove a data field from the data card 210. When a data field is removed, control dialog 300 is operable, according to aspects, to warn the user of any relationships to data fields that have not been removed and request confirmation of the removal.

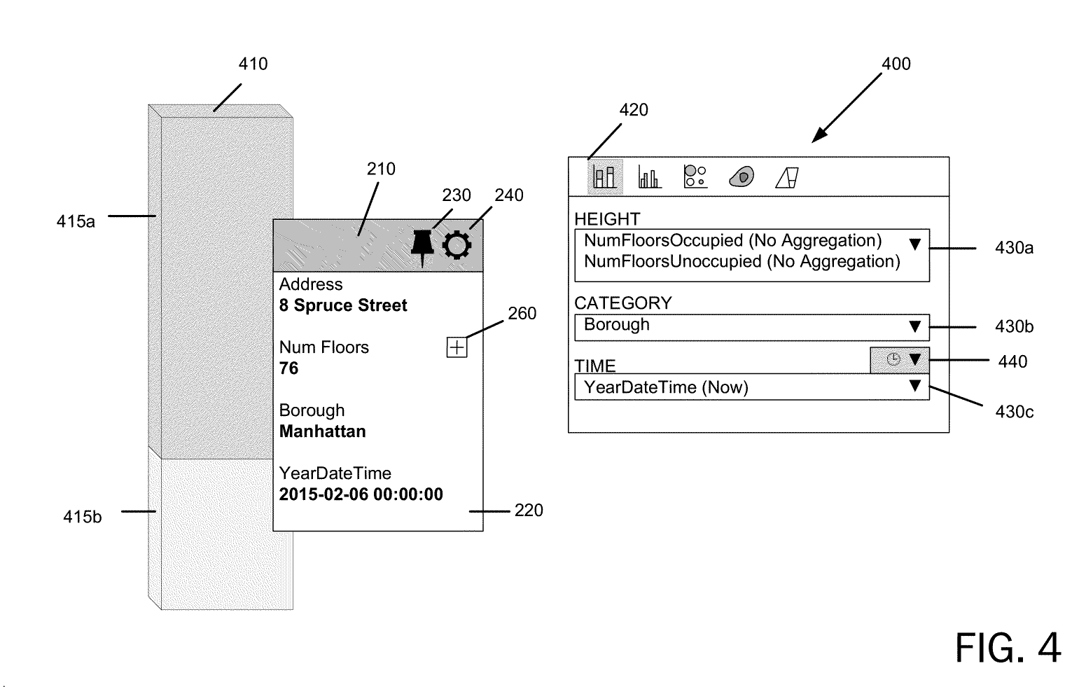

FIG. 4 is an illustration of a visualization control 400 for a data visualization in coordination with a data card 210. According to various aspects, visualization control 400 is accessible via a menu, ribbon command, or dedicated control related to the data visualization or via selecting customization control 240 as a component of customization dialog 300 or as a standalone control operable to affect the display of a visualized data point 410 within the data visualization. A visualized data point 410 is presented as part of a data visualization for displaying a visual representation of a data point, and may have data cards 210 associated therewith.

A visualized data point 410, according to different aspects, may display several subsets of related or unrelated data that are associated with the data point as layers 415a, 415b (collectively 415). As will be understood, layers 415 need not be displayed on top of one another; the term indicates a distinction between data subsets used in data visualizations. In various aspects, the visualization control 400 provides various layer visualization option controls 420 operable to change how layers 415 are presented in relation to a data point, such as, for example, stacked columns, clustered columns, bubble charts, heat maps, or user-defined presentations. Visualized data point 410 is illustrated in FIG. 4 according to a stacked column visualization option with layer 415a on top of layer 415b, but visualized data point 410 may be displayed according to other visualization options, (e.g., clustered columns, etc.) where layer 415a and 415b are not displayed on top of one another.

Each visualization option presents corresponding visualization fields 430 within visualization control 400 to set how data subsets associated with the data point are categorized for use in the data visualization. Data subsets presented in the visualization fields 430 associated with the data point are displayed according to the visualization option. Although illustrated as a stacked column, other visualization types are possible for a visualized data point 410, including, but not limited to: pie charts/wedges, markers, bubbles, colorations (e.g., heat maps), and combinations thereof.

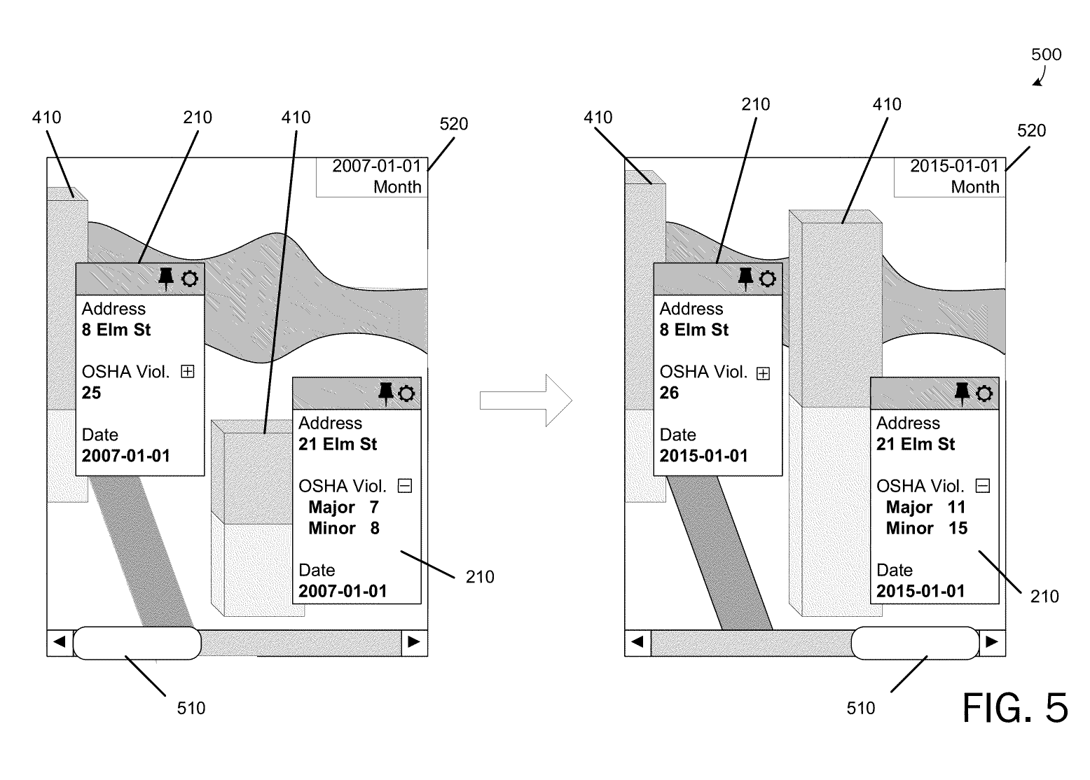

Visualization control 400 is illustrated to affect a stacked column visualization option with: visualization field 430a to select and modify which data subsets are set as layers 415 affecting the visualization; visualization field 430b to select which data subsets are set as categories, and are presentable in an associated data card 210; and visualization field 430c to select a data subset for use as a time dimension. When a visualization option includes a visualization field 430 for a time dimension, aspects provide for a time stamp control 440, which is operable to affect the presentation of data over time, which will be discussed in greater detail in relation to FIG. 5. Aspects of the time stamp control 440 provide for several options for extra-dimensional display, including, but not limited to: display of the current/closest value in time, display of values accumulated over time according to a selected aggregation, and display of the latest value in time (i.e., the largest or smallest value in the extra dimension).

Although examples and terminology herein are given in relation to time being the extra dimension, this is for purposes of simplicity, and other non-time values (e.g., altitude, velocity, mass, color, product line, etc.) may be used as an extra dimension. For example, a data point correlating to a given stretch of road is visualized in the X and Y dimensions of that stretch of road on a two-dimensional map, which displays the average miles per gallon via a Z dimension, can substitute vehicle weight, average speed, or weather conditions, among other possibilities, for time as the extra dimension for display. In another example, data points representing restaurants may be displayed in a data visualization to correlate to the location of the restaurant and may display revenue mapped to a height of the visualized data point, which may originally vary based on time that the revenue data was collected, but the time dimension may be substituted for a number of wait staff as an extra dimension so that the relationship between revenue and the number of waiters present may be explored.

FIG. 5 illustrates an example time slider 500. A time slider 500 allows for a user to visualize data as it changes over a period of time or across a different value set selected in place of time. According to aspects, the time slider 500 affects the entire data visualization or selected data points within the data visualization. As the time slider 500 is advanced or regressed along a time variable, such as the extra dimension set in the visualization control 400, discussed above, the data visualization is updated accordingly, per the time stamp control 440. For example, as illustrated in FIG. 5, when a slider control 510 is set to a first time, two visualized data points 410 and their associated data cards 210 are shown at the first time. When the slider control 510 is advanced to a second time, the two visualized data points 410 and associated data cards 210 are updated to show data relevant to the second time. The slider control 510 may similarly be regressed from the second time to the first time, where the two visualized data points 410 and data cards 210 will be updated to show data associated with the first time.

In various aspects, the current time, according to the slider control 510, is displayed in a time box 520, to provide a user with a useful indication of the time used for display of the data visualization. In some aspects, the time box 520 is operable to display a step size used by the slider control 510. Each step size correlates to available positions for the slider control 510 to access to provide relevant data from. For example, a step size for a time dimension may be set to hourly, daily, monthly, quarterly, yearly, etc.

The time dimension, however, may be imperfectly captured in some examples, such as when the sampling rate for live data, or historical sampling rate for archived data is greater than or less than the step size, or if at the same rate as the step size, has been collected at a different time than the ideal step size would indicate, (e.g., on the fifth minute of the hour instead of the first minute of the hour, on even months instead of odd months, etc.). Additionally, data may be missing for a given point in time for a given data point. Data cards 210 allow for the imperfectly captured data to be displayed alongside perfectly captured data over time while alerting a user to the inconsistency. When the data point has a sampling rate greater than the step size (e.g., when the step size is quarterly, but the entity samples monthly), the data may be aggregated according to the data card template and indicate to the user, via the data card 210, that more samples are available to drill-down into. When the data point has a sampling rate lower than the step size (e.g., when the step size is monthly, but the entity samples quarterly) or data is otherwise missing, approximation (e.g., dividing quarterly values by three for use in each step, using the quarterly values as-is for three steps, displaying last available data/value and the time it was acquired, displaying an error message and no data, etc.) according to the data card template may be used and indicated to the user, via the data card 210, that approximation has occurred. Alternatively, the data card 210 may show a blank value unless the time values match exactly for the data being displayed. Aggregation and approximation may be indicated to a user according to various aspects, including, but not limited to: color changes, warning icons, flashing, etc.

When a data point has data that were collected at a different time than the ideal step size indicates, an alert may be sent to notify a user that a data offset can be set. Data offsets, as mentioned in relation to FIG. 3, are set via customization dialog 300. Offsets are operable to allow data sampled at a different time than the ideal step size indicates to be treated as though they were collected at the ideal time. For example, when one data point has associated data sampled five minutes later than all other data points of interest, a user may offset that data point. The offset may be to modify time values by five minutes or to set the time values to round to the closest hour when a precise offset is not an optimal solution. In another example, a user may set an offset that truncates unwanted precision from time values, such as, for example, monthly reports including the minute and second at which they were sampled. Alternatively, offsets may be set so that a user may view information associated with one data point at a different starting time from a second data point as the slider control 510 advances both evenly according to the step size. For example, a user may wish to compare monthly accident rates for two factories, but wishes to compare a first factory's data for 2007 against a second factory's data for 2008; an offset of one year may be added to the first factory's or the second factory's data (negative or positive respectively) so that slider control 510 can evenly advance each set of data, despite having different start times.

Individual data cards 210 may be locked in time so that the values displayed on the data card 210 remain static as the slider control 510 advances or regresses in the time dimension.

As will be understood, although the slider control 510 is illustrated as a scroll bar, several other options for a slider control 510, such as, for example, play/pause/fast forward/rewind command buttons, a wheel object, and direct text input can be used as slider controls 510. In various aspects, slider control 510 is subject to manual and automatic control (e.g., the system may automatically control slider control 510 to advance through several time values or loop the display). Time slider 500, in various aspects, may smooth transitions between each data visualizations for each value in the extra/time dimension, such that the data visualization animates, or leave the transitions unsmoothed to “jump” to the display of each data visualization for each value in the extra dimension.

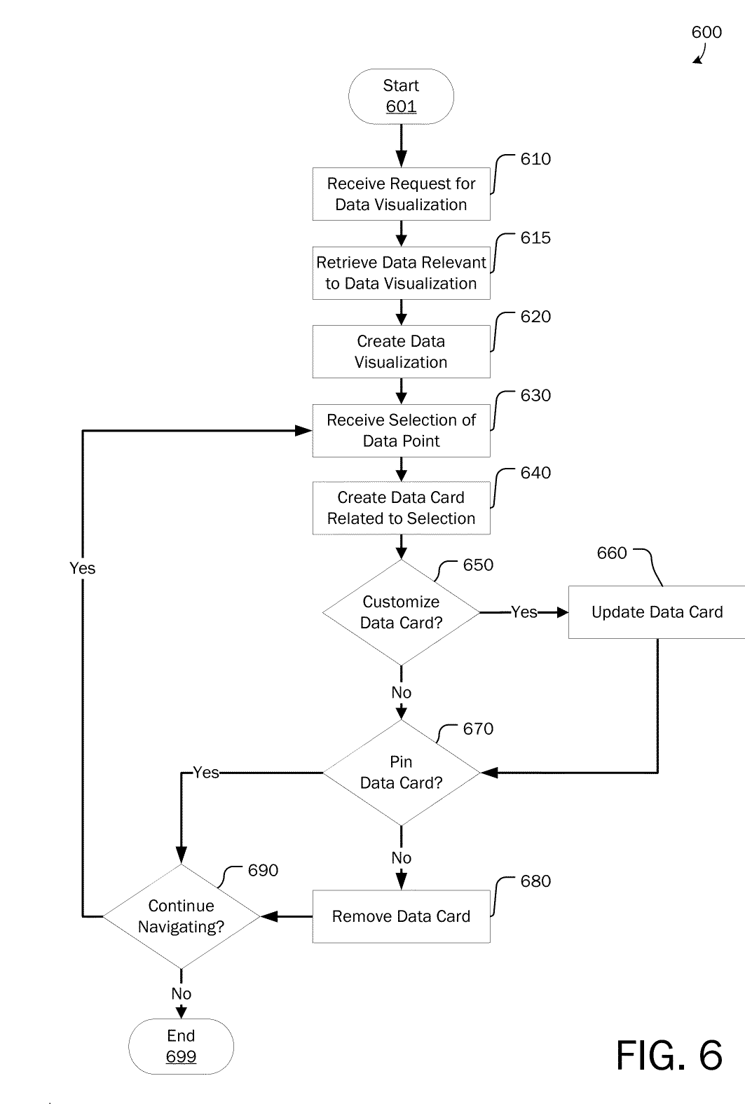

FIG. 6 is a flow chart of an example method 600 for presenting a custom drill-down view of data at a specific data point within a data visualization. Method 600 begins at START 601 and proceeds to OPERATION 610, where a request for a data visualization is received. According to various aspects, a request for a data visualization includes query criteria. Method 600 proceeds to OPERATION 615, where data that are relevant to the requested data visualization are retrieved.

Once data meeting the query criteria have been retrieved, method 600 proceeds to OPERATION 620, where the data are used to create a data visualization. The data visualization created in OPERATION 620 enables a user to navigate the data to find data points of interest, which the user may desire to view additional information about. According to various aspects, users may select a data point of interest via several different events. One example event is the user clicking on a data visualization point 410 via a mouse or touchscreen device. Another example event is a user hovering a cursor over a data visualization point 410 for a predetermined amount of time (e.g., 333 ms, 0.5 s, etc.). Yet another example event is a user entering a textual sub-query associated with the data point.

Method 600 receives a selection of a data point via an event in OPERATION 630 and then proceeds to OPERATION 640, where a data card 210 is created for the selected data point. When creating the data card 210, information related to the data point populates the data card 210. This information may be data used in creating and rendering the visualized data point 410 (e.g., the X,Y,Z coordinate data within the data visualization, layer data, time dimension data, etc.) or may be non-visualized data related to the data point or an entity represented by the data point (e.g., unused visualization data, rich text descriptions, images, videos, audio files, hyperlinks, etc.). According to an aspect, the information that initially populates the data card 210 is based on a default template and the user query that requested the data visualization. The information is retrieved on-the-fly or in real-time so that the user is presented with the most recent information available.

Aspects enable the information to be periodically re-queried (e.g., sampled) so that the information may be cached temporarily or stored long-term to enable the data card 210 to accumulate information over time. Time accumulated information is used in various aspects for data aggregation or for use with a time slider 500 as discussed in relation to FIG. 5. After the data card 210 has been created, it may be rendered on a computing device or transmitted to another computing device.

At DECISION OPERATION 650 a determination is made whether a user has selected to customize the data card 210. OPERATION 650 may be accessed from a ribbon, take pane, or an interface from an existing data card 210, such as in the data card 210 created in OPERATION 640. When it is determined at DECISION OPERATION 650 that the user selected to customize the data card 210, method 600 proceeds to OPERATION 660. Otherwise, method 600 proceeds to DECISION OPERATION 670.

At OPERATION 660, method 600 updates the data card 210 based on the customizations selected by the user, such as, for example, via a customization dialog 300 or a visualization control 400. The data card 210 is then updated according to the selected customization, such that updated information is queried to populate the data card 210. This updated information may include new aggregation schemes, previously selected information, and information that was not previously selected, and is requested on-the-fly. New queries for sampling real-time data are generated based on the information selected during customization. In some aspects, the customization may result in changes to the data card template such that other data cards 210 sharing the same data card template are updated as well. After the update to the data card 210 of OPERATION 660 is complete, method 600 proceeds to DECISION OPERATION 670.

Method 600 proceeds to DECISION OPERATION 670, where it is determined whether the data card 210 is to be pinned. When a determination is made that a data card 210 is to be pinned, such as, for example, when a user selects a pin control 230 on the data card 210, the data card 210 will remain visible and active in the data visualization and method 600 proceeds to DECISION OPERATION 690. When it is determined that the data card 210 is not pinned, such as, for example, when a user unselects or chooses not to select a pin control 230 on the data card 210, method 600 proceeds to OPERATION 680.

At OPERATION 680 method 600 waits for an event to remove the data card 210 from the data visualization. One example event is the user clicking on a visualized data point 410 or the data card 210 via a mouse or touchscreen device for a second time (the first time being an event to display the data card 210) to dismiss the data card 210. Another example event is a user removing a cursor from a visualized data point 410 or the data card 210 (i.e., hovering elsewhere) for a predetermined amount of time (e.g., 333 ms, 0.5 s, etc.). Yet another example event is a timeout, wherein the data card 210 is displayed for a predetermined amount of time (e.g., 5 s, 10 s, etc.) and will be removed automatically at the end of that predetermined time unless it is pinned. After an appropriate event is detected, method 600 removes the data card 210 and proceeds to DECISION OPERATION 690.

At DECISION OPERATION 690 method 600 determines whether a user continues navigating the data visualization. If the user indicates that navigation is complete, such as, for example, by closing the data visualization, method 600 terminates at END 699. Otherwise, method 600 returns to OPERATION 630 and navigation of the data visualization continues until the user indicates that navigation is complete. Once navigation is complete, aspects provide for data and information on pinned data cards 210 to be present when navigation is resumed; data cards 210 that are pinned may persist across sessions.

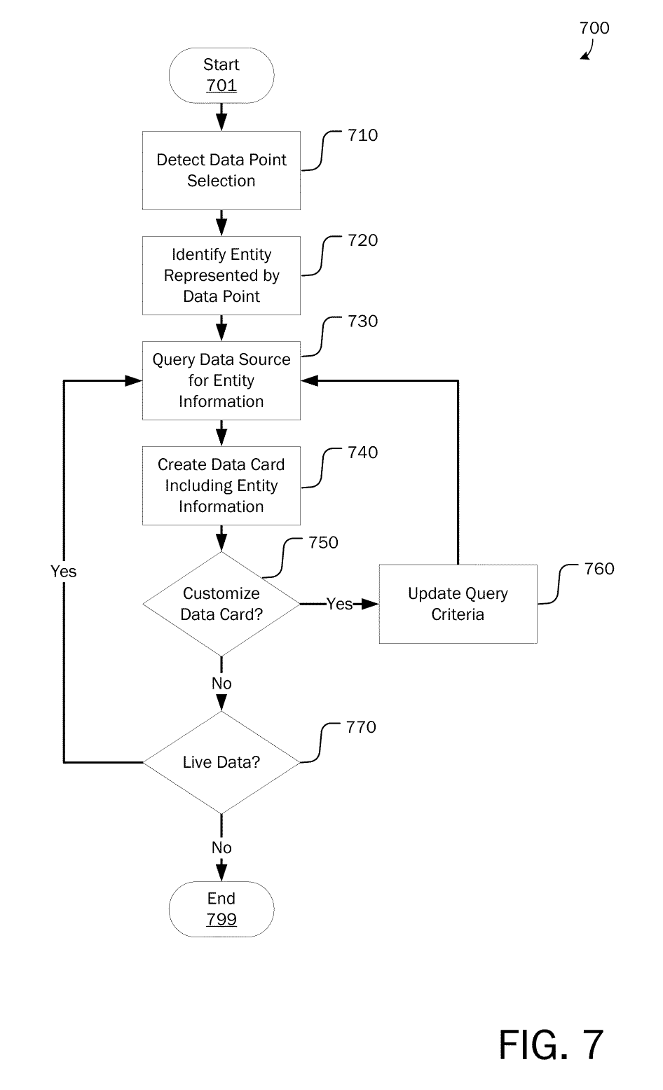

FIG. 7 is a flow chart of an example method 700 for populating a data card 210. Method 700 begins at START 701 and proceeds to OPERATION 710 where a selection of a data point is detected. When detecting the selection of a data point, method 700 is operable, according to aspects, to discriminate between several potential data points to choose one data point as the selected data point, such as, for example, when the resolution of the data visualization is such that several visualized data points 410 are displayed in a selected region of the data visualization.

Once a data point is selected in OPERATION 710, method 700 proceeds to OPERATION 720, where the entity that is represented by the data point is identified. According to aspects, method 700 is operable to incorporate the initial query used, which was to create the data visualization, as a factor to identify the entity represented by the data point. For example, in a data visualization based on a query for a mapping of restaurants, a user has selected a data point associated with the geographic points of a building housing a restaurant and a laundromat. Because the data point is associated with two entities, but the query for the data visualization was for restaurants, method 700 is operable to identify the restaurant as the entity of interest represented by the data point. In another example, when two restaurants share a data point, such as when the data point represents a building having multiple tenants, method 700 is operable to choose one or both restaurants as entities represented by the data point.

When an entity has been identified in OPERATION 720, method 700 proceeds to OPERATION 730, where information about the entity is queried. In some aspects, because the initial data visualization includes initial information about displaying the data point that may be relevant to the entity (such as positional data for the data point within the data visualization), an initial query includes the initial information. Method 700 is operable in various aspects to query for data in OPERATION 730 through various sources. In various aspects, data sources include locally stored data and cached data, such as files stored on the computing device used to display the data visualization or data temporarily held in active memory or in temporary files. In other aspects, data may be queried from remote sources, for example, from networked databases, external websites, RSS feeds, or via direct signals, such as from sensors and instruments providing live data. Data queries are manually directed by a user in some aspects, such as, for example, by designating a specific database or series of databases to query information from. In other aspects, method 700 automatically selects a data source. Automatic selection of a data source is enabled in some aspects by using a search engine (e.g., the Bing® search engine offered by MICROSOFT CORPORATION of Redmond, Wash.) to find data sources to query from. In yet other aspects, a hybrid manual/automatic select is enabled, such as, for example, when method 700 automatically selects a series of data sources and presents those sources to a user for approval before querying those data sources.

Once information about the entity has been queried from the data source in OPERATION 730, method 700 proceeds to OPERATION 740, where a data card 210 that includes the information returned in the query is created. Because the data card 210 is not created or populated with information before a data point has been selected, the most recent information related to the data point is displayed in the data card 210. Additionally, by waiting to query for information related to the data point until a user selects a data point, less memory and fewer computing resources are consumed. Once the data card 210 has been created, it may be rendered on a computing device or transmitted to another computing device.

Method 700 proceeds to DECISION OPERATION 750 to determine whether the user has selected to customize the data card 210. Users can select to customize a data card 210 to format or alter which data are presented in the data card 210, and may select from several data card templates to apply customizations to the data card 210. According to aspects, the templates are both system-created and user-created, and templates can be created and saved for later use, as is discussed in relation to FIG. 3. In some aspects, when a user selects a data point, the data card template, whether saved or not, of the previously selected data point is first applied to the data card 210 of the newly selected data point. According to aspects, customization changes how the information is displayed on the data card 210 (e.g., changing a table to a graph on the data card 210, reordering the display of information, changing the formatting within the data card 210, changing aggregation of information, etc.). According to other aspects, customization changes the information on the data card 210 (e.g., adding or removing data fields, changing dependencies between data fields, changing data sources for data fields, etc.).

When it is determined that a user has indicated a customization to a data card 210, method 700 proceeds to OPERATION 760 where updates are made to the query criteria used to populate the data card 210 with information. Method 700 then returns to OPERATION 730 where data sources are queried for information, the query now based on the updated query criteria, to populate the data card 210.

When data card 210 is not customized, method 700 proceeds to DECISION OPERATION 770 to determine whether live data exists for the data card 210. Live data includes data that is being updated or has been updated while the data visualization is displayed as well as data that has been updated since the last time the data visualization was displayed; enabling the display of the most up-to-date information in the data card 210. Users, in various aspects, can designate sampling rates, at which rate live data is to be re-queried for. In other aspects, users can designate static data (i.e., non-live data) as live data, to ensure, the most up-to-date data is used. Similarly, users can designate live data as static data to prevent re-querying, for example, to view a snapshot of data or conserve system resources, memory, or bandwidth. When it is determined that data is live, method 700 returns to OPERATION 730 where data sources are re-queried for the most up-to-date information. When it is determined that the data is not live, method 700 terminates at END 799.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which aspects are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

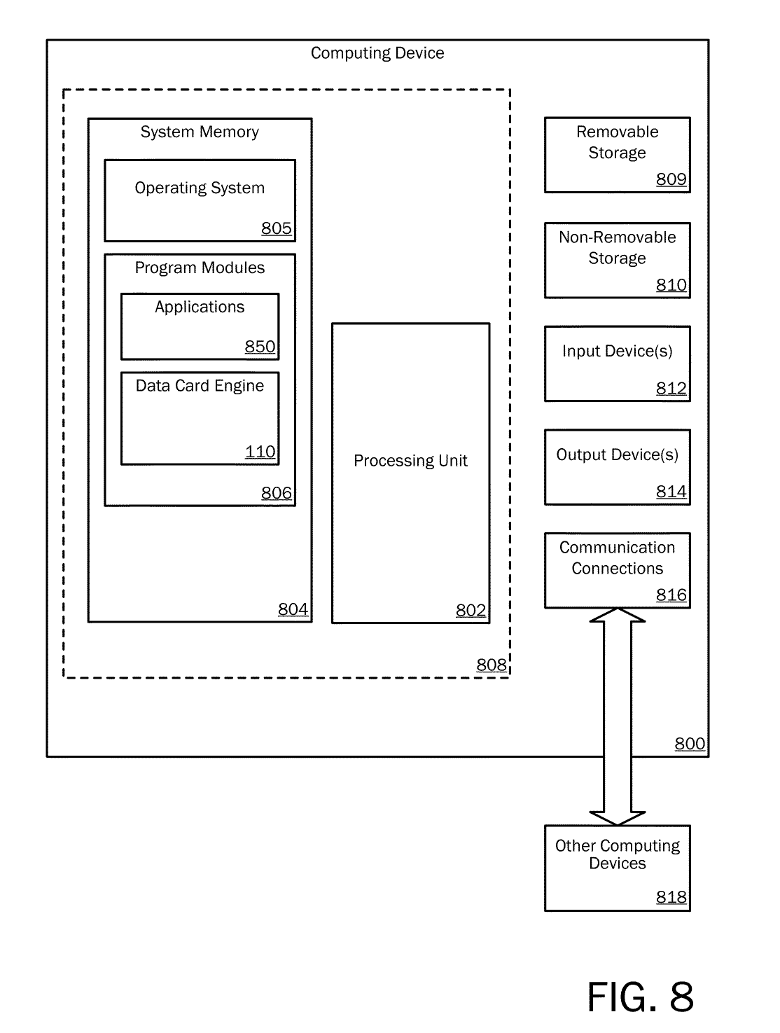

FIG. 8-10 and the associated descriptions provide a discussion of a variety of operating environments in which examples of the present disclosure are practiced. However, the devices and systems illustrated and discussed with respect to FIGS. 8-10 are for purposes of example and illustration and are not limiting of a vast number of computing device configurations that are used for practicing aspects, described herein.

FIG. 8 is a block diagram illustrating physical components (i.e., hardware) of a computing device 800 with which examples of the present disclosure can be practiced. In a basic configuration, the computing device 800 includes at least one processing unit 802 and a system memory 804. According to an aspect, depending on the configuration and type of computing device, the system memory 804 comprises, but is not limited to, volatile storage (e.g., random access memory), non-volatile storage (e.g., read-only memory), flash memory, or any combination of such memories. According to an aspect, the system memory 804 includes an operating system 805 and one or more program modules 806 suitable for running software applications 850. According to an aspect, the system memory 804 includes the data card engine 110. The operating system 805, for example, is suitable for controlling the operation of the computing device 800. Furthermore, aspects are practiced in conjunction with a graphics library, other operating systems, or any other application program, and is not limited to any particular application or system. This basic configuration is illustrated in FIG. 8 by those components within a dashed line 808. According to an aspect, the computing device 800 has additional features or functionality. For example, according to an aspect, the computing device 800 includes additional data storage devices (removable and/or non-removable) such as, for example, magnetic disks, optical disks, or tape. Such additional storage is illustrated in FIG. 8 by a removable storage device 809 and a non-removable storage device 810.

As stated above, according to an aspect, a number of program modules and data files are stored in the system memory 804. While executing on the processing unit 802, the program modules 806 (e.g., data card engine 110) performs processes including, but not limited to, one or more of the stages of the methods 600, 700 illustrated in FIGS. 6 and 7. According to an aspect, other program modules are used in accordance with examples of the present disclosure and include applications such as electronic mail and contacts applications, word processing applications, spreadsheet applications, database applications, slide presentation applications, drawing or computer-aided application programs, etc.

Aspects of the present disclosure are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 8 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 800 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 800 has one or more input device(s) 812 such as a keyboard, a mouse, a pen, a sound input device, a touch input device, etc. The output device(s) 814 such as a display, speakers, a printer, etc. are also included according to an aspect. The aforementioned devices are examples and others may be used. According to an aspect, the computing device 800 includes one or more communication connections 816 allowing communications with other computing devices 818. Examples of suitable communication connections 816 include, but are not limited to, RF transmitter, receiver, and/or transceiver circuitry; universal serial bus (USB), parallel, and/or serial ports.

The term computer readable media as used herein includes computer storage media. Computer storage media include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. According to an aspect, any such computer storage media is part of the computing device 800. Computer storage media do not include a carrier wave or other propagated data signal.

According to an aspect, communication media is embodied by computer readable instructions, data structures, program modules, or other data in a modulated data signal, such as a carrier wave or other transport mechanism, and includes any information delivery media or transmission media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

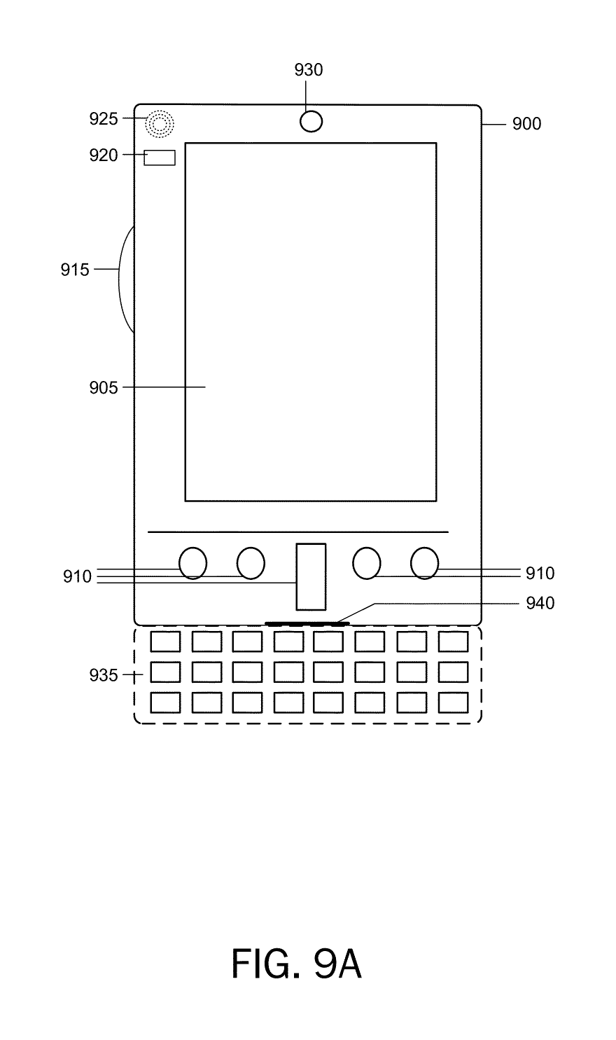

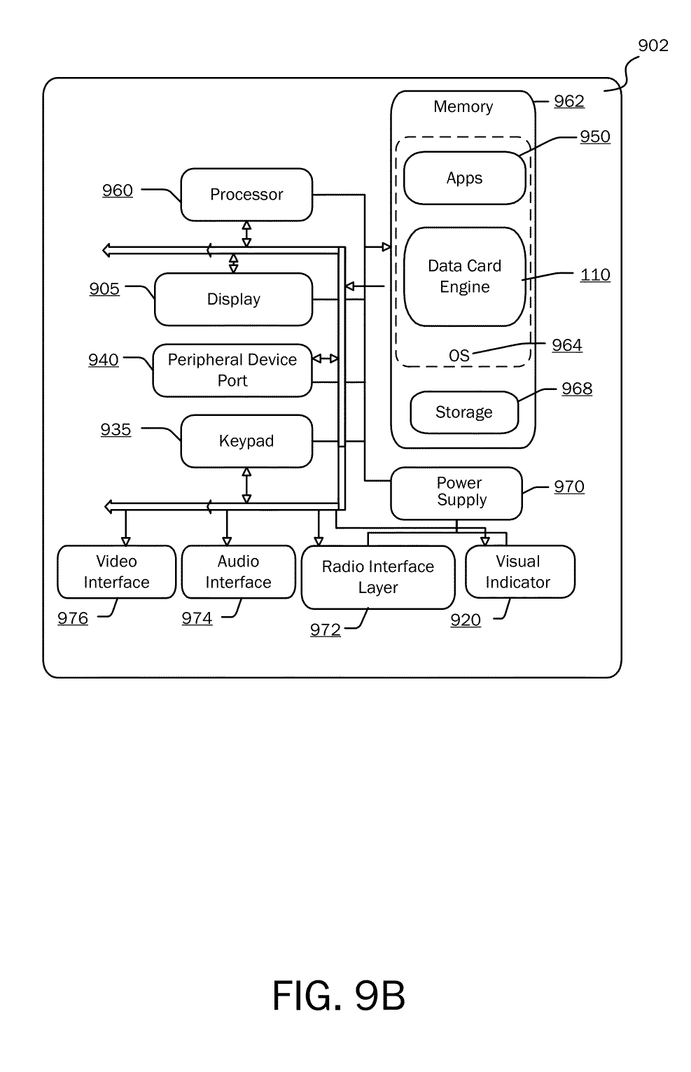

FIGS. 9A and 9B illustrate a mobile computing device 900, for example, a mobile telephone, a smart phone, a tablet personal computer, a laptop computer, and the like, with which aspects may be practiced. With reference to FIG. 9A, an example of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. According to an aspect, the display 905 of the mobile computing device 900 functions as an input device (e.g., a touch screen display). If included, an optional side input element 915 allows further user input. According to an aspect, the side input element 915 is a rotary switch, a button, or any other type of manual input element. In alternative examples, mobile computing device 900 incorporates more or less input elements. For example, the display 905 may not be a touch screen in some examples. In alternative examples, the mobile computing device 900 is a portable phone system, such as a cellular phone. According to an aspect, the mobile computing device 900 includes an optional keypad 935. According to an aspect, the optional keypad 935 is a physical keypad. According to another aspect, the optional keypad 935 is a “soft” keypad generated on the touch screen display. In various aspects, the output elements include the display 905 for showing a graphical user interface (GUI), a visual indicator 920 (e.g., a light emitting diode), and/or an audio transducer 925 (e.g., a speaker). In some examples, the mobile computing device 900 incorporates a vibration transducer for providing the user with tactile feedback. In yet another example, the mobile computing device 900 incorporates peripheral device port 940, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one example of a mobile computing device. That is, the mobile computing device 900 incorporates a system (i.e., an architecture) 902 to implement some examples. In one example, the system 902 is implemented as a “smart phone” capable of running one or more applications (e.g., browser, e-mail, calendaring, contact managers, messaging clients, games, and media clients/players). In some examples, the system 902 is integrated as a computing device, such as an integrated personal digital assistant (PDA) and wireless phone.

According to an aspect, one or more application programs 950 are loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. According to an aspect, the data card engine 110 is loaded into memory 962. The system 902 also includes a non-volatile storage area 968 within the memory 962. The non-volatile storage area 968 is used to store persistent information that should not be lost if the system 902 is powered down. The application programs 950 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900.

According to an aspect, the system 902 has a power supply 970, which is implemented as one or more batteries. According to an aspect, the power supply 970 further includes an external power source, such as an AC adapter or a powered docking cradle that supplements or recharges the batteries.

According to an aspect, the system 902 includes a radio 972 that performs the function of transmitting and receiving radio frequency communications. The radio 972 facilitates wireless connectivity between the system 902 and the “outside world,” via a communications carrier or service provider. Transmissions to and from the radio 972 are conducted under control of the operating system 964. In other words, communications received by the radio 972 may be disseminated to the application programs 950 via the operating system 964, and vice versa.

According to an aspect, the visual indicator 920 is used to provide visual notifications and/or an audio interface 974 is used for producing audible notifications via the audio transducer 925. In the illustrated example, the visual indicator 920 is a light emitting diode (LED) and the audio transducer 925 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 925, the audio interface 974 may also be coupled to a microphone to receive audible input, such as to facilitate a telephone conversation. According to an aspect, the system 902 further includes a video interface 976 that enables an operation of an on-board camera 930 to record still images, video stream, and the like.

According to an aspect, a mobile computing device 900 implementing the system 902 has additional features or functionality. For example, the mobile computing device 900 includes additional data storage devices (removable and/or non-removable) such as, magnetic disks, optical disks, or tape. Such additional storage is illustrated in FIG. 9B by the non-volatile storage area 968.

According to an aspect, data/information generated or captured by the mobile computing device 900 and stored via the system 902 is stored locally on the mobile computing device 900, as described above. According to another aspect, the data is stored on any number of storage media that is accessible by the device via the radio 972 or via a wired connection between the mobile computing device 900 and a separate computing device associated with the mobile computing device 900, for example, a server computer in a distributed computing network, such as the Internet. As should be appreciated such data/information is accessible via the mobile computing device 900 via the radio 972 or via a distributed computing network. Similarly, according to an aspect, such data/information is readily transferred between computing devices for storage and use according to well-known data/information transfer and storage means, including electronic mail and collaborative data/information sharing systems.

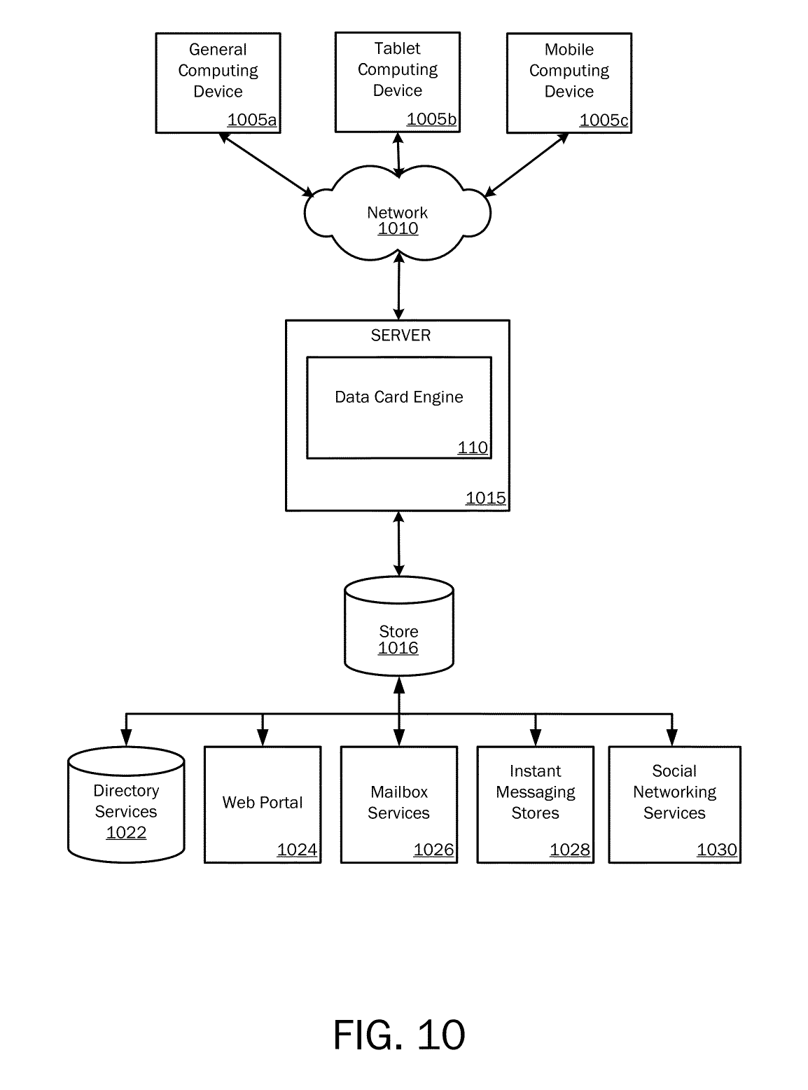

FIG. 10 illustrates one example of the architecture of a system for providing a real-time presentation of customizable drill-down views of data at specific data points as described above. Content developed, interacted with, or edited in association with the data card engine 110 is enabled to be stored in different communication channels or other storage types. For example, various documents may be stored using a directory service 1022, a web portal 1024, a mailbox service 1026, an instant messaging store 1028, or a social networking site 1030. The data card engine 110 is operable to use any of these types of systems or the like for providing real-time presentation of customizable drill-down views of data at specific data points, as described herein. According to an aspect, a server 1015 provides the data card engine 110 to clients 1005a-c. As one example, the server 1015 is a web server providing the data card engine 110 over the web. The server 1015 provides the data card engine 110 over the web to clients 1005 through a network 1010. By way of example, the client computing device is implemented and embodied in a personal computer 1005a, a tablet computing device 1005b or a mobile computing device 1005c (e.g., a smart phone), or other computing device. Any of these examples of the client computing device are operable to obtain content from the store 1016.

Aspects of the present disclosure, for example, are described above with reference to block diagrams and/or operational illustrations of methods, systems, and computer program products. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope of the present disclosure as claimed in any way. The aspects, examples, and details provided in this application are considered sufficient to convey possession and enable others to make and use the best mode claimed. The present disclosure should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the present disclosure.

We claim:

1. A system for presenting customized subsets of data related to a data point within a data visualization, comprising:
a processor;
a memory;
a visualization application, operable to provide the data visualization, wherein visualized data points are displayed; and
a data card engine in communication with the visualization application, operable to provide data cards associated with the visualized data points in response to the visualized data points being selected from the data visualization, further comprising:
an entity identification module, operable to receive a selection of the visualized data points from the visualization application and to identify entities represented by each of the selected visualized data points;
a query module, operable to retrieve data related to the entities for display in the data cards; and
a construction module, operable to build the data cards in response to the visualized data points being selected, wherein building the data cards includes displaying the data related to the entities in the data cards, the construction module further operable to update the data cards in response to a customization of one of the data cards, wherein the customization of the one of the data cards includes communicating the customization to the query module to retrieve new data related to the entities for display in the data cards and building the data cards with the new data.

2. The system of claim 1, wherein the construction module is operable to build and update the data cards according to a template, the template specifying data fields to display in the data cards, an order for displaying the data fields, and a manner for displaying the data fields.

3. The system of claim 2, wherein the one of the data cards shares the template with a second data card, the construction module being further operable to update the template and thereby the second data card in response to the customization of the one of the data cards.

4. The system of claim 1, wherein the new data related to the entities includes at least one of:
an addition of a data field;
a removal of a data field;
a changed aggregation for a data field; and
a changed data source for a data field.

5. The system of claim 1, wherein the data cards are operable to be pinned within the data visualization, wherein a pinned data card is operable to persist within the data visualization when a second visualized data point is selected.

6. The system of claim 1, the query module being further operable to retrieve the data related to the entities in real time, wherein the data is retrieved in response to the visualized data points being selected.

7. The system of claim 1, wherein the visualization application is further operable to provide an extra dimension for the visualized data points displayed in the data visualization, wherein the extra dimension is not used to define a position or a displayed value of the visualized data points in the data visualization.

8. The system of claim 7, wherein the construction module is further operable to provide a time stamp control to provide options for how the extra dimension affects how the visualized data points are displayed in the data visualization and the data cards, including at least one of:
display of a cumulative value over the extra dimension;
display of a value related to an extra-dimensional value closest to a specified extra-dimensional value;
display of a value related to a largest extra-dimensional value; and
display of a value related to a smallest extra-dimensional value.

9. The system of claim 7, wherein the extra dimension is time.

10. The system of claim 1, wherein the visualized data points are selected from the data visualization via a cursor hovering over the visualized data points in the data visualization.

11. A method for presenting customized subsets of data related to a data point within a data visualization, comprising:
detecting a selection of a visualized data point within the data visualization;
identifying an entity represented by the visualized data point;
querying a data source for information related to the entity based on query criteria;
creating a data card for the visualized data point;
displaying the data card in the data visualization, wherein the data card displays the information queried for;
receiving a customization input for the data card;
in response to receiving the customization input, updating the query criteria;
querying the data source for updated information related to the entity based on the updated query criteria; and
displaying, via the data card, the updated information queried for.

12. The method of claim 11, wherein the query criteria are based on an initial request for the data visualization.

13. The method of claim 11, wherein the data card is operable to be pinned within the data visualization, wherein pinning the data card causes the data card to remain displayed within the data visualization when a second visualized data point is selected.

14. The method of claim 11, wherein the data card is defined by a template, wherein the template includes the query criteria and a format for displaying the information queried for, wherein the template is operable to receive the customization input for the data card, the method further comprising:
in response to receiving the customization input via the template, updating the query criteria of a different data card, wherein the different data card is defined by the template.

15. The method of claim 11, further comprising:
periodically re-querying the data source based on the updated query criteria, wherein the data source provides live data; and
accumulating the live data to provide as the information in the data card.

16. The method of claim 15, wherein the accumulated data is organized according to a time dimension, based on when the data were periodically queried for, comprising:
presenting the accumulated live data at a given time in the time dimension;
advancing the presentation of the accumulated data in the time dimension; and
regressing the presentation of the accumulated data in the time dimension.

17. The method of claim 11, wherein the data card is further operable to display information not used in the data visualization within the data card as at least one of:
a graph;
a chart;
a collapsible list;
an image;
a video;
an audio file; and
a hyperlink.

18. A computing device for presenting customized subsets of data related to a data point within a data visualization, comprising:
a processor; and
a memory, including instructions, which when executed by the processor are operable to:
provide data cards according to an initial template in response to receiving selections of the data point within the data visualization, wherein the data cards are operable to display data related to the data points specified by the initial template;
query for the data related to the data points specified by the initial template;
populate the data cards with the queried for data related to the data points specified by the initial template;
receive a customization to the initial template to produce a customized template, the customized template specifying different data related to the data points to display in the data cards than the initial template specifies, wherein the different data related to the data points includes at least one of:
an addition of a data field;
a removal of a data field;
a changed aggregation for a data field; and
a changed data source to query a data field from;
query for the different data related to the data points specified by the customized template; and
populate the data cards with the different data related to the data points specified by the customized template.

19. The computing device of claim 18, wherein the subsets of the data include a time dimension, the data cards being further operable to display the subsets of the data at a given value in the time dimension or an aggregation of the subsets of the data from a period in the time dimension.

20. The computing device of claim 18, wherein the data cards are operable to be pinned within the data visualization, wherein a pinned data card is operable to persist within the data visualization while a different data card is displayed within the data visualization.
